(19) United States
(12) Patent Application Publication
(10) Pub. No.: US 2011/0035692 A1
(43) Pub. Date: Feb. 10, 2011

(54) Scalable Architecture for Dynamic Visualization of Multimedia Information

(75) Inventors: Randall J. Sandone, Urbana, IL (US); Emile P. Bataille, Cary, IL (US); Michael J. Sandone, Savoy, IL (US); Jill Adams, Chicago, IL (US); Ashok Rathinam, Reston, VA (US); Dhanachandran Elandkuppan, Chennai (IN); Santhanakrishnan Padmanaban, Chennai (IN)

Correspondence Address: BARNES & THORNBURG LLP, P.O. Box 2786, CHICAGO, IL, 60690-2786, US

(73) Assignee: VISUAL INFORMATION TECHNOLOGIES, INC., Urbana, IL (US)

(21) Appl. No.: 12/864,272

(22) PCT Filed: Jan. 26, 2009
(86) PCT No.: PCT/US09/32003

§ 371 Date: Oct. 11, 2010

Related U.S. Application Data
(60) Provisional application No. 61/023,649, filed on Jan. 25, 2008.

(51) Int. Cl. G06F 3/048

(52) U.S. Cl. 715/769; 715/810

(57) ABSTRACT

A computer system including a single, fully-integrated software program that allows an unskilled computer user to create, archive, and distribute interactive, multimedia digital displays without the use of software programming techniques or reliance on software editing tools. The system includes a user interface having a digital content creation application called a digital canvas and an integrated software application dock. The digital canvas module provides a novice user with all of the functional tools needed to create multimedia visual displays and to interact with them. The application dock allows users to launch and operate desktop applications such as web browsers, word processing applications, photo editing applications, spreadsheets, graphics applications, etc. as well as server-based applications, such as database systems available over a network from within the system.

The present application claims priority to U.S. Provisional Patent Application Ser. No. 61/023,649 filed on Jan. 25, 2008, which is herein incorporated by reference.

### BACKGROUND AND SUMMARY

The present disclosure relates to a system and method allowing a user to create digital multimedia displays. In particular, the system of the present disclosure includes a single, fully integrated software program that allows an unskilled computer user to create, archive, and distribute interactive, multimedia digital displays without the use of software programming techniques or reliance on software editing tools. The system of the present disclosure supports the collection, aggregation, organization, and annotation of digital information artifacts, or objects, from sources found within a computer's file system, from networked file systems, from attached systems and/or storage devices, from online publishing systems, or from streaming data sources. The system includes of two main modules: a digital content creation application, also referred to as a digital canvas, and an integrated software application dock.

The digital canvas module provides a user with all of the functional tools needed to create multimedia visual displays and to interact with them. The application dock allows users to launch and operate desktop applications such as web browsers, word processing applications, photo editing applications, spreadsheets, graphics applications, etc. as well as server-based applications, such as database systems available over a network, from within the system. Application programs may be launched from a menu panel or by activating file links and/or executable scripts attached to objects placed on a digital canvas.

One aspect of the present disclosure includes a system for generating a dynamic multi-dimensional data representation within a virtual display domain. The system includes a mass storage device, a source module, a destination module, and a user interface module. The user interface module is connected to the mass storage device, the source module, and the destination module, and is configured to display contents of the source module and the destination module, wherein the user interface module allows for selection of a digital object having predefined properties from the source module and transfer of the digital object and all of its predefined properties to the destination module without modification of computer program code.

Another aspect of the present disclosure is a method for generating within a predetermined virtual display domain, a visual multi-dimensional data representation, the method including the steps of: selecting at least one information unit from a source environment; grouping the information units into at least one digital object; positioning the digital object within a plane of the virtual display domain; locking the position of the digital object using a point-and-click menu selection module; ordering the digital object normal to the plane of the virtual display domain; assigning and formatting an attribute of the digital objects, and assigning a hyperlink address to the digital object, the hyperlink address having an associated data type, wherein the hyperlink address launches an application software module within a web browser, the software application module being configured for a specified data type.

Another aspect of the present disclosure is a computer readable medium having program code stored thereon for manipulating digital data, when executed on a computer, causing the computer to: provide a user interface displaying a source domain and a destination domain, the source domain including one or more digital objects, allow a user to select at least one digital object and position the digital object on the destination domain, and allow the user to assign an attribute to the digital object.

### BRIEF DESCRIPTION OF THE DRAWINGS

The present disclosure will be described hereafter with reference to the attached drawings which are given as a non-limiting example only, in which:

FIG. 1 is a representation of a high-level overview of the system of the present disclosure showing a user interface including a virtual desktop having a digital canvas and an application dock with an open web browser;

FIG. 1A is a high level schematic representation illustrating assignment of attributes to objects on the digital canvas;

FIG. 2 is a schematic representation of the system of the present disclosure;

FIG. 3 is a graphical representation of the system of the present disclosure;

FIG. 4 illustrates creation of a graphical object on the digital canvas of the system of the present disclosure;

FIG. 5 illustrates creation of a text object on the digital canvas of the system of the present disclosure;

FIG. 6 illustrates creation of video and audio objects on the digital canvas of the system of the present disclosure;

FIG. 7 illustrates creation of a file link attribute associated with an object on the digital canvas of the present disclosure;

FIG. 8 illustrates creation of a note attribute associated with an object on the digital canvas of the present disclosure;

FIG. 9 illustrates creation of an image object attribute associated with a note attribute associated with a text object on the digital canvas of the present disclosure, creating a cascade of information;

FIG. 10 illustrates creation of a caption attribute associated with an image object on the digital canvas;

FIG. 11 illustrates creation of an audio attribute associated with an image object on the digital canvas;

FIG. 12 illustrates creation of an video clip attribute on the digital canvas;

FIG. 13 illustrates creation of a slide show by associating additional images with an image object on the digital canvas;

FIG. 14 illustrates sequencing of object on the digital canvas;

FIG. 15 illustrates an example of the launch pad application of the system of the present disclosure;

FIG. 16 illustrates an example of copying an object from the digital canvas to an application running in the application dock of the system of the present disclosure; and

FIG. 17 illustrates an example of adjusting the magnification of objects on the digital canvas.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

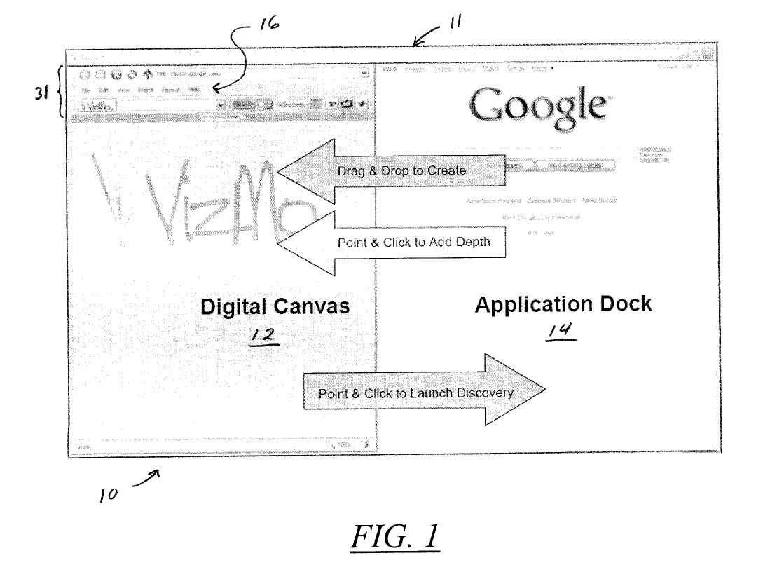

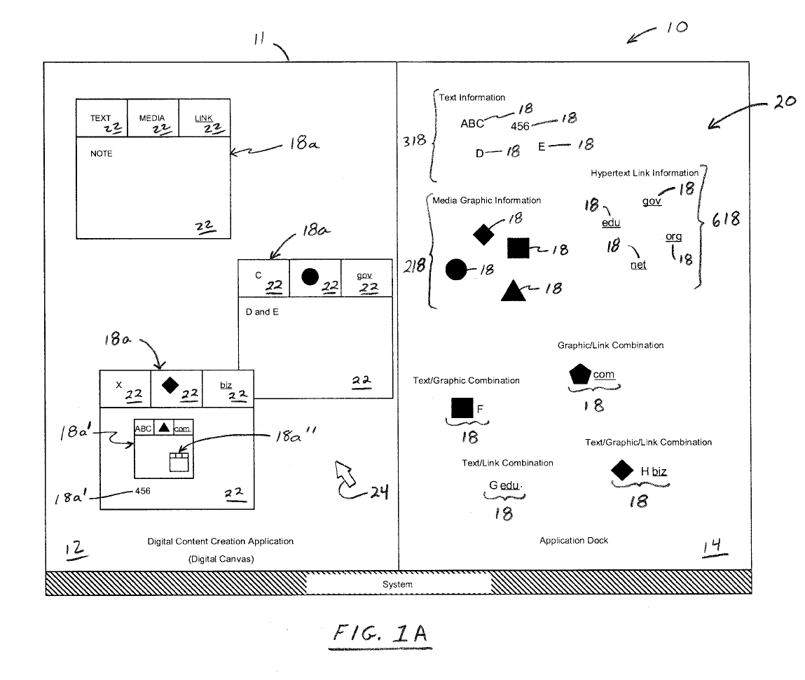

The present disclosure is directed towards a system 10 including a single, fully integrated software program that allows an unskilled computer user to create, archive, and distribute interactive, multimedia digital displays without the use of software programming techniques or reliance on software editing tools. The system of the present disclosure supports the collection, aggregation, organization, and annotation of digital information artifacts, or objects, from sources found within a computer's file system, from networked files systems, from attached systems and/or devices, from online publishing systems, or from streaming data sources. The system includes two main modules: a digital content creation application, herein referred to as a digital canvas 12; and an integrated software application dock 14, as shown in FIG. 1.

The digital canvas module 12 provides a novice user with all of the functional tools needed to create multimedia visual displays and to interact with them. The application dock 14 allows users to launch and operate desktop applications such as web browsers, word processing applications, photo editing applications, spreadsheets, graphics applications, etc. as well as server-based applications, such as database systems available over a network from within the system 10. Application programs may be launched from a menu panel 16 or by activating file links and/or executable scripts attached to objects placed on a digital canvas 12.

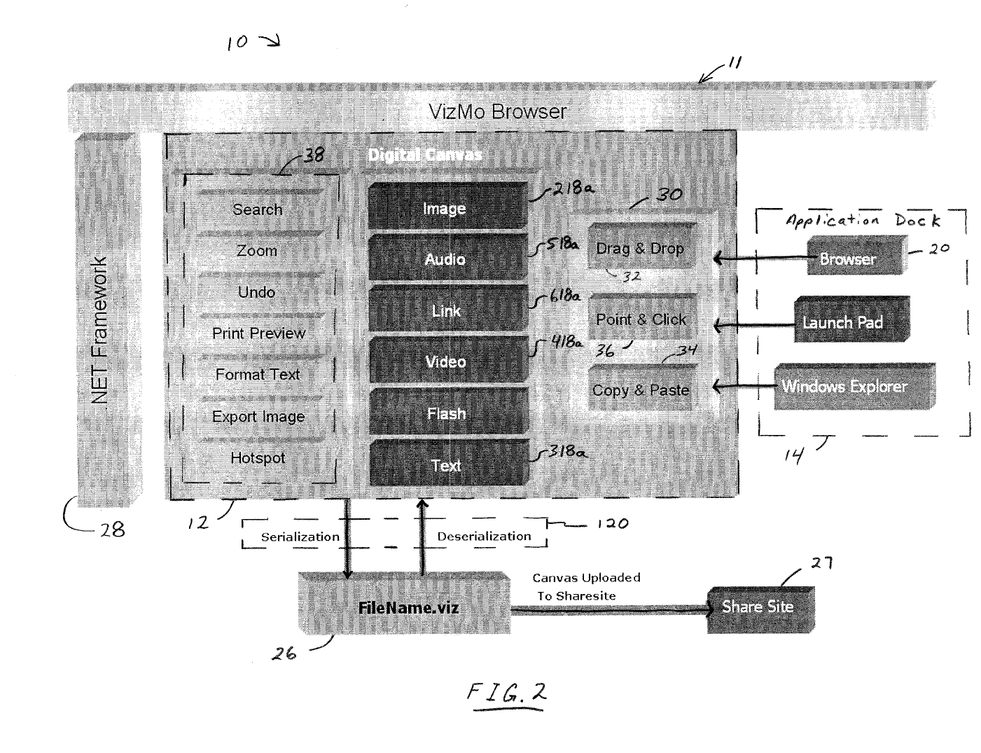

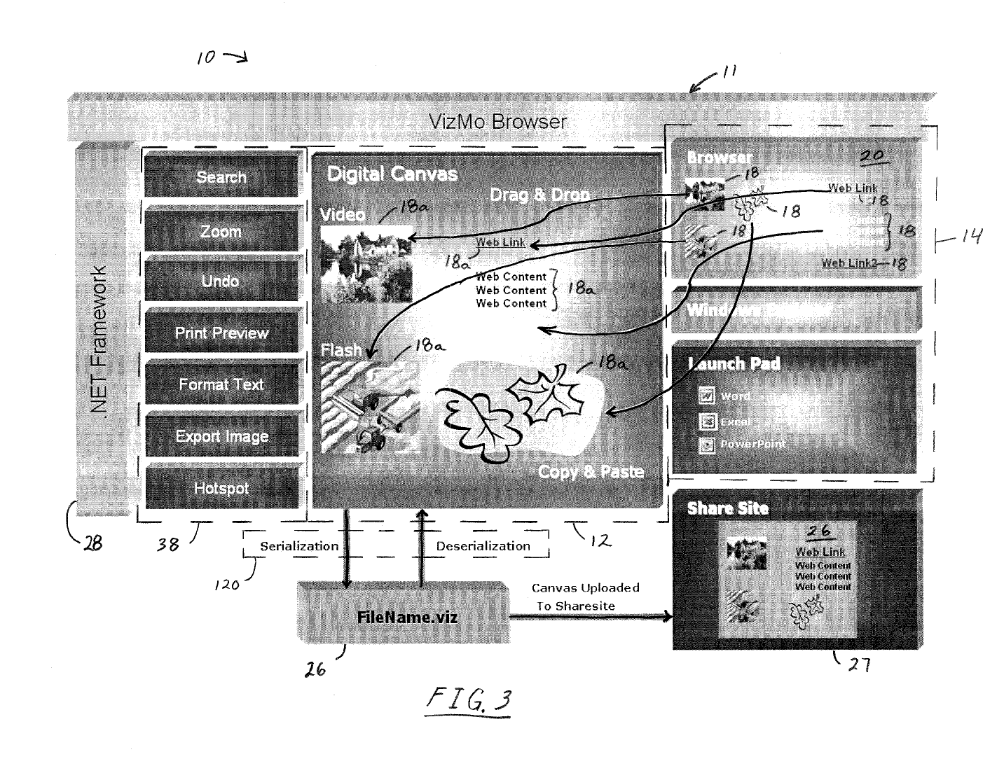

Referring to FIGS. 2 and 3, to create multimedia displays using a general purpose computer, a user locates and transfers digital objects, or artifacts, 18 such as images, photos, text, hyperlinks, file links, audio and video clips, etc., from a source 20 such as a web page, file folder, online repository, application file, etc., and places the object 18 on the surface of the canvas 12. Each digital object may consist of one or more information units. A user may transfer an object 18 from its source to the digital canvas 12 via a user interface module 30, which includes a selection module and a transfer module. Interface module 30 provides insert, drag-and-drop 32, copy-and-paste 34, point-and-click 36, operations, among others, all without the need to program computer code and without the need of pre-existing templates. Once placed on the surface of the digital canvas 12, the digital object 18a can be re-sized, rotated, flipped, and placed anywhere on the digital canvas 12 surface at selected x-y coordinates, including overlapping other objects 18a. If multiple objects 18a are arranged in an overlapping or layering configuration, the user can select the plane (i.e. select a z coordinate) for each object 18 relative to other objects. The object 18a can be grouped with other objects and/or locked in place on the digital canvas 12 surface.

A background image (including but not limited to a map, photo, texture image, wallpaper, template, CAD drawing, or drawing) can be assigned to a digital canvas 12 and objects 18a can be placed, grouped, and/or locked in place against that background image.

FIG. 1A shows a high-level schematic representation of assignment of attributes 22 to objects 18a located on the digital canvas 12. The system 10 of the present disclosure includes a user interface having a virtual display or virtual desktop 11 including a digital canvas 12 and application dock 14. In the illustration of FIG. 1A, a software program running in the application dock 14 is the source 20 of digital artifacts or objects 18 to be transferred to digital canvas 12. These artifacts or objects 18 could include (but are not limited to) digital graphic information/data 218, text information/data 318, hypertext or link information/data 618, as well as audio, video, and/or flash or streaming information/data (not shown) as well as information containing combinations of the aforementioned information/data types. As described herein, a data acquisition and manipulation module allows a user to modify properties of digital objects 18a and to associate multiple digital objects together creating a cascading hierarchy of parent and child digital objects.

Once digital objects 18a are placed on the digital canvas 12, the user can assign a variety of attributes 22 to those objects. Those attributes 22 may be additional digital objects, which include (but are not limited to): hyperlinks, file links, notes/commentary, audio clips, images, executable scripts, links to streaming or real time data feeds, and captions. Additionally, both the digital object 18a and the associated attribute may be visible on the digital canvas at all times (persistent visibility) or may be invisible until the occurrence of some action by the user or by the system (transient visibility). After a digital object 18a has been assigned attributes 22, the digital object retains those particular attributes even if the digital object is moved, copied, or grouped with other digital objects on digital canvas 12.

For example, once assigned to an object 18a, the attributes 22 may be hidden from view until activated by placing (hovering) a mouse cursor 24 over the object 18a. Upon placing the mouse cursor 24 over the object (parent) 18a, a secondary object (child) 18a′ appears to display the hidden attributes assigned to the primary object 18a.

Within this secondary object 18a′, additional objects (links, photos, graphical elements, etc.) can be inserted via drag-and-drop, copy-and-paste, or direct “insert” operations. Attributes 22 can be assigned to these secondary objects 18a′ as well. As with the primary objects 18a, attributes 22 assigned to a secondary object 18a′ may be hidden from view until the mouse cursor 24 is placed over the secondary object 18a′ revealing a tertiary object 18a″, and so forth—creating a cascading effect of objects within objects.

Active links and executable scripts assigned as attributes 22 to objects 18a, secondary objects 18a′, and tertiary objects 18a″, etc., are invoked via a “double-click” of the mouse cursor 24 on the object. Once invoked via this double-click, the link or script is launched and the appropriate application is opened in the application dock 14 or in a separate program frame/window as appropriate, without further intervention of the user.

The user's actions may be automatically recorded by the system 10 so that the sequence of actions (placement of objects) can be displayed to a viewer. The sequence can be freely modified by the user. Once sequences are assigned (either automatically or by user customization), a routine can be invoked to reveal visible numbers attached to each object on the digital canvas 12 representing their order in the sequence. Another routine can be invoked to play an animation that will show the incremental construction of the canvas based on the assigned sequence.

A completed digital canvas 12 can be saved as a digital file 26 in a variety of file formats and can be stored on any appropriate digital media including a computer hard drive, removable storage media such as magnetic and/or optical discs, attached to an email, or uploaded/transferred to remote computers connected over a network 28. FIGS. 2 and 3 illustrate digital file 26 uploaded to a web-based file share site 27, for example.

Referring to FIG. 1, when a user operates the system 10 of the present disclosure, the system software executes to create a user interface having a virtual desktop 11 on the user's computer screen. As shown in the exemplary embodiment, on the left side of the desktop 11, the system 10 presents the user with a user interface including a control panel 31 and digital canvas 12 having a blank workspace, onto which a user can collect digital objects 18 from virtually any source 20 to create a multi-dimensional interactive visual display. On the right side of the desktop 11, the system provides an application dock 14 where the user can launch and operate other applications, such as a web browser, word processor, spreadsheet, database, audio/video player, or other software application. No programming is required to create, archive and/or transfer an interactive, multimedia digital canvas. Simple drag-and-drop techniques allow a user to transfer content from the active program in the application dock 14 to the digital canvas 12, and vice versa. The system 10 supports context-sensitive menus for custom formatting, which are activated through intuitive point-and-click procedures.

A wide variety of digital object types, including but not limited to hyperlinks, application files, images, videos, audio clips, pictures, slide shows, text, active code objects (frequently referred to as “widgets”), and animations can be inserted on to a digital canvas 12 using simple drag and 32 drop techniques, copy and paste 34, or insert operations. These digital objects 18 can be acquired from web pages, application files, or directories located on the users computer, transportable media such as flash drives, CD, or DVD, or any computer or digital device linked to the user's computer directly or over a network.

Once placed on the digital canvas 12, a digital object 18a can be freely moved, resized, overlaid, or grouped with other digital artifacts or objects using free-form placement techniques with the mouse pointer 24 acting as the handling device. Clicking the right mouse button on the object 18a presents the user with a menu 38 of choices to add additional elements, or attributes 22, to the object 18a. The user can add or edit a web link 618a (link to a webpage) or a link to an application file to the object 18a. Once added to the object 18a, a double-click of the mouse pointer 24 on the object 18a will launch the link which will open the webpage or application file in the application dock 14 on the right side of the virtual desktop 11 of the present system or in a separate frame/window as appropriate. The user can also add and edit and format a text note 318a about the object 18a, which will pop-up when the mouse pointer 24 is held stationary, or hovered, over the object 18a. The user can also add and, edit, and format a caption that can be attached to the object 18a and will remain visible on the digital canvas 12. Users can also add a video or an audio recording to the object 18a. This audio component allows the user to record voice commentary regarding the object 18a.

A user may add an executable script to any object 18a on the digital canvas 12. This script (for instance a database query) will execute upon a double-click on the object 18a and the output of the script will run in the application dock 14 or in a separate frame/window as appropriate. In addition, users can search internal data stores, drag and drop file links or individual blocks of text, tables, charts, or graphics contained within those files. All of which can be freely positioned, linked, annotated, and labeled.

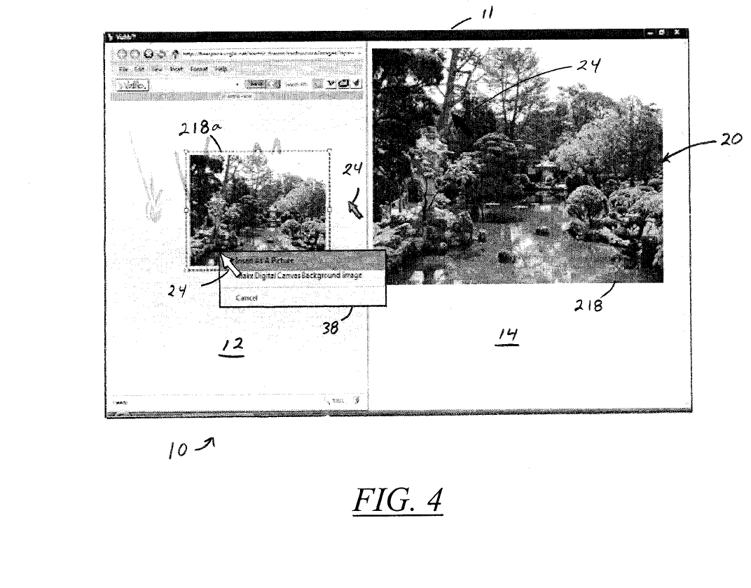

Referring to FIG. 4, the system 10 of the present disclosure includes a drag-and-drop module, which allows a user to drag and drop graphical digital objects 218 from a source 20 (such as a photo file) to the digital canvas 12 surface. In the exemplary embodiment, a graphical digital object 218 is acquired with the mouse cursor 24 by clicking the left mouse button, dragged and dropped on the digital canvas surface 12 where it is then inserted as a picture 218a. The graphical digital object 218a can then be re-sized, rotated, flipped, and placed anywhere on the digital canvas 12 surface. Through a copy-and-paste operation, the graphical digital object 218a can be copied as many times as desired and each copy placed anywhere on the digital canvas 12 surface as its own distinct object. The attributes assigned to the graphical digital object 218a are retained by the digital object even if it is moved, copied, or grouped with other digital objects on digital canvas 12.

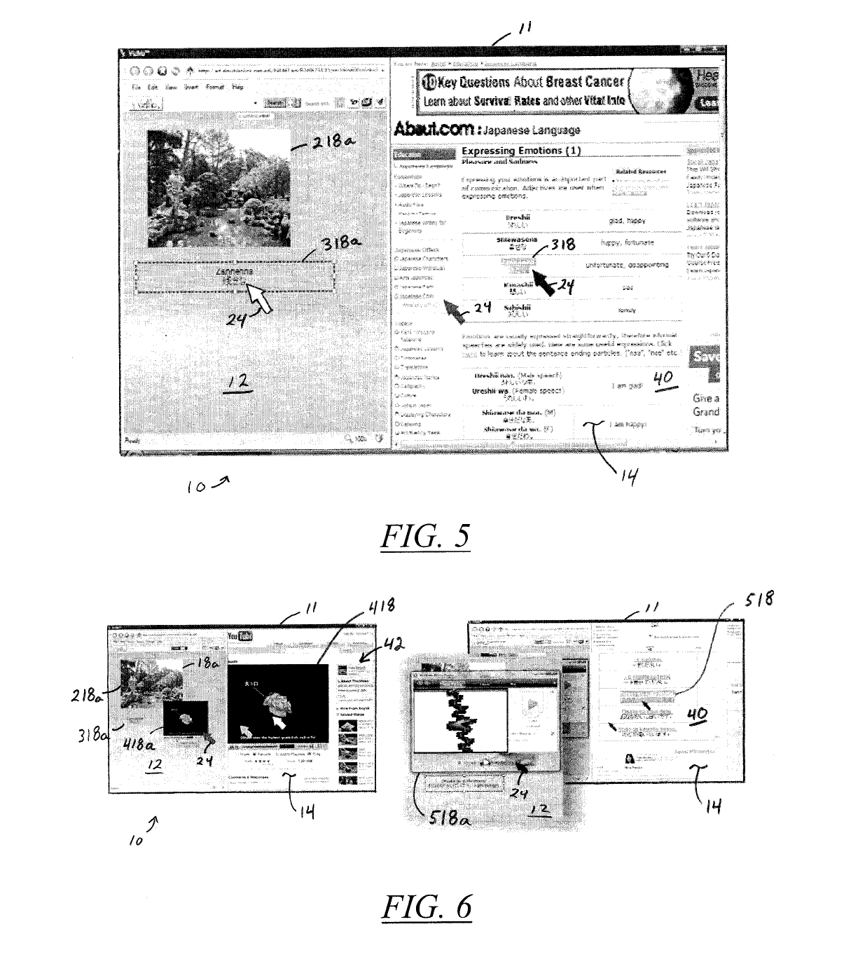

In a similar manner, a user may drag and drop text 318 from a source (such as a web page) to the digital canvas 12 surface, as shown in FIG. 5. For example, text 318 on a web page 40 is first highlighted, then acquired with the mouse cursor 24, dragged and dropped 32 on the digital canvas 12 surface where it displayed in its own digital text object region 318a. The text digital object can then be re-sized, and placed anywhere on the surface. The text in the text digital object 318a can be formatted (font, style, color, size, etc.) as desired. Also, a region surrounding the text can be assigned a background color and a border by a user. Through a copy and paste operation, the text digital object 318a can be copied as many times as desired and each copy placed anywhere on the digital canvas 12 surface as its own distinct object.

Referring now to FIG. 6, a user can drag and drop linked active content, such as a video or audio clip, active code object, or data feed, from a source to the digital canvas 12 surface. As appropriate, these active objects may include embedded control panels for activation and manipulation of the content. For example, a video clip 418 is identified on a webpage 42, then acquired with the mouse cursor 24, dragged and dropped 32 on the digital canvas 12 surface where it is inserted as a linked active content digital object 418a. The linked active content digital object 418a can then be re-sized, and placed anywhere on the digital canvas 12 surface. FIG. 6 also shows an audio file digital object 518a being transferred to the digital canvas 12 surface in the same manner. Through a copy-and-paste operation 34, the object(s) 418a, 518a can be copied as many times as desired and each copy placed anywhere on the digital canvas surface 12 as its own distinct object. A double-click on the linked active content object 418a or 518a on the digital canvas 12 will invoke the link to the video or audio clip which will play on the target website or by activating an appropriate media player, whichever is appropriate.

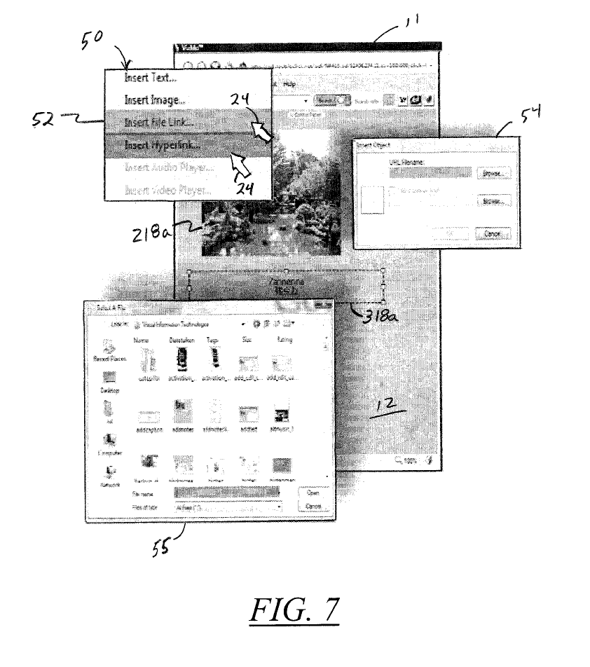

The system 10 of the present disclosure also contains a file link module, which allows a user to link a file to an object 18a located on the digital canvas 12 surface as an attribute 22 through point and click operations 36. In the example shown in FIG. 7, the mouse cursor 24 is placed over the photo digital object 218a and the right mouse button is depressed to activate the attributes menu 50. The user selects “Insert File Link” 52 from the menu 50, browses his file directory 54, 55, locates the desired file and selects the file. That file is now linked to the photo digital object 218a. A double-click on the photo will launch the file link 618a and the file will open in the application dock 14.

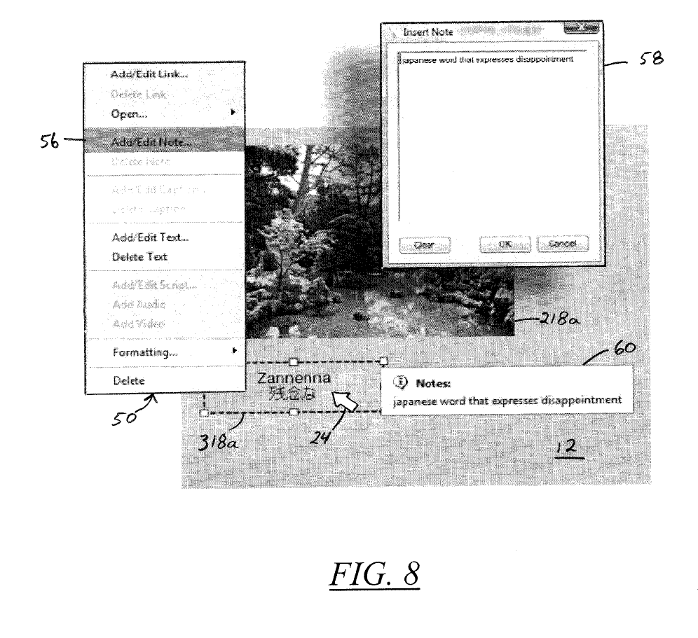

A user may add a note or commentary to an object located on the digital canvas 12 surface as an attribute through an annotation module included in the system 10 of the present disclosure. In the example shown in FIG. 8, the mouse cursor 24 is placed over the photo digital object 218a and the right mouse button is depressed to activate the attributes menu 50. The user selects “Add/Edit Note” 56 from the menu 50. A blank note pad 58 is opened. The user can type a note or paste in text from any other source via the copy-and-paste operation. The note's text can be formatted (font, font size, color, style, etc.). When the user is satisfied with his note/commentary he/she clicks on “OK” to attach the note attribute 60 to the photo digital object 218a. The note pad 58 disappears from view. When the mouse cursor 24 is placed over the photo digital object 218a the note will appear in a “Notes” box as shown in FIG. 8. The user may also insert objects 18 into the note attribute 60 (links, photos, etc.) which could contain their own attributes—creating a cascading information resource.

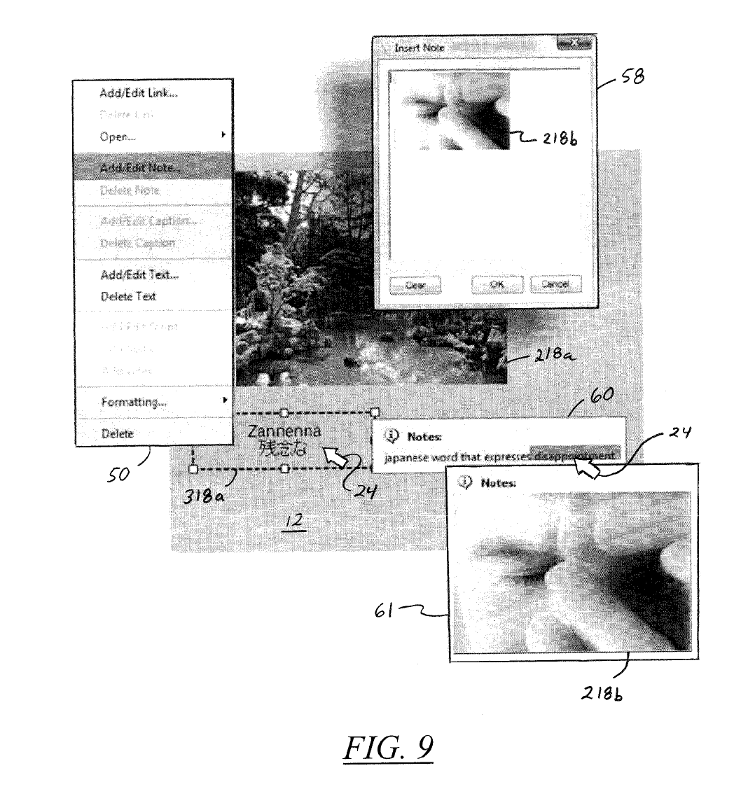

An example of this cascading of information is illustrated in FIG. 9. An image digital object 218b is attached to the word “disappointment” in the Notes attribute 60 of the text digital object 318a. Placing the mouse cursor over the word “disappointment” reveals the cascading “Notes” attribute 61 showing the image digital object 218b. In this particular example, image 218b is a photo of a person with his hand to his face and eyes closed, visually reinforcing the word “disappointment”.

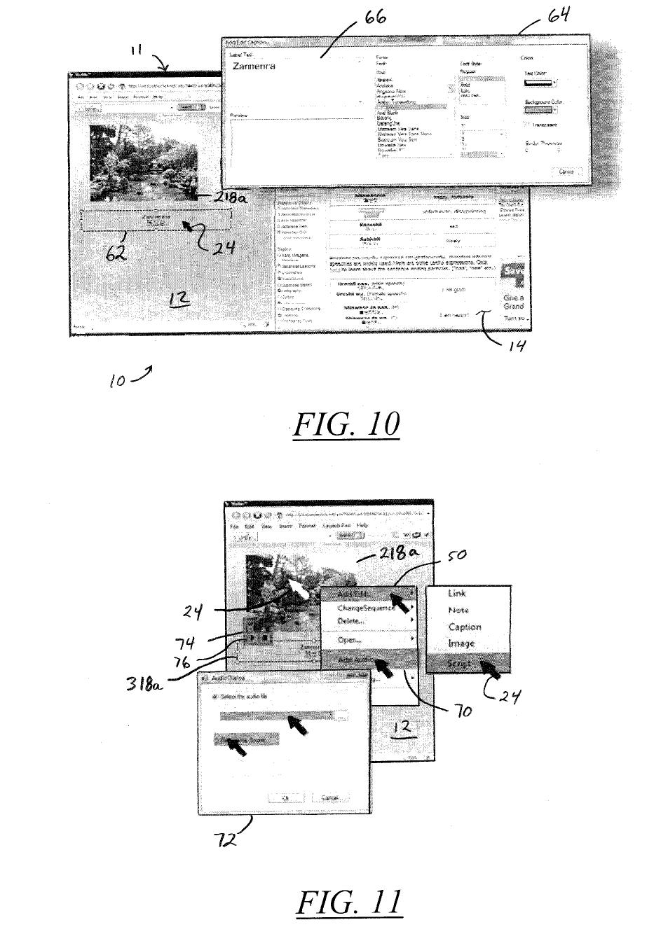

In another aspect of the system 10 of the present disclosure, a caption module allows a user to add a text caption attribute 62 to an object located on the digital canvas 12 surface, as shown in FIG. 10. For example, the mouse cursor 24 is placed over the photo digital object 218a and the right mouse button is depressed to activate the attributes menu (not shown). The user selects “Add/Edit Caption” from the menu. A text formatting palette 64 is opened. The user can type or paste in text from any other source via the copy and paste operation 34 into the text box 66 within the palette. The text can then be formatted (font, style, size, color, etc.) as desired. When the user is satisfied he clicks on “OK” to attach the caption 62 to the photo digital object 218a. The formatting palette disappears from view. The user may select the position where the formatted caption appears: below, above, or to the side of the object. The caption 62 moves and scales with the object as an integral element of the object unless and until removed by the user.

Another aspect of the system 10 of the present disclosure, an active content module, allows a user to add active audio content or an audio clip as an active content attribute to an object located on the digital canvas 12 surface. For example, as shown in FIG. 11, the mouse cursor 24 is placed over the photo digital object 218a and the right mouse button is depressed to activate the attributes menu 50. The user selects “Add Audio” 70 from the menu 50. An audio attribute dialog box 72 is opened. The user can choose to browse to locate a pre-recorded audio clip (music, voice, etc.) or the user can choose to record an audio clip. When the user has either located and selected the audio file or recorded his audio clip, the user selects “OK”. The audio attribute dialog box 72 disappears from view. An icon 74 representing a loudspeaker appears in a corner of the object 218a to indicate that an audio file is attached to the object as an attribute. Placing the mouse cursor over that icon 74 opens a “start/stop” toggle switch 76 allowing the user to play and stop the audio clip. A discreet audio player that is not associated with another object can also be placed on the canvas surface via “Insert Audio Player” function and freely positioned.

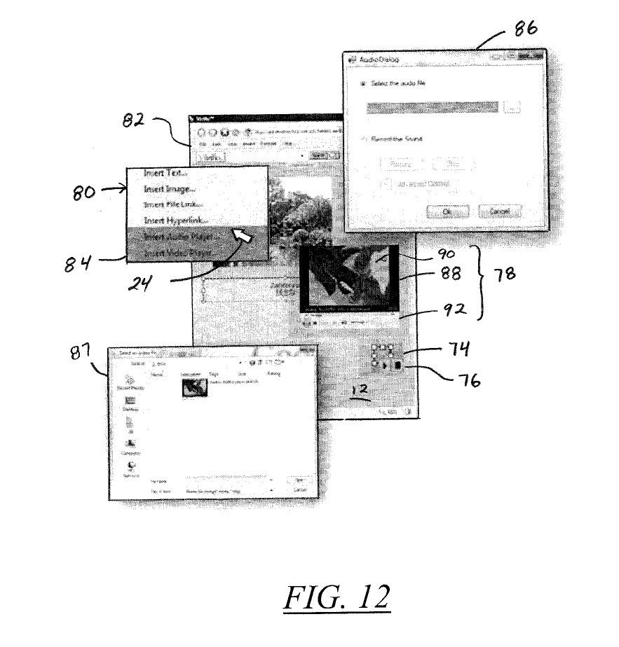

The active content module also allows a user to insert a video clip attribute 78 as active content to the digital canvas 12 surface. In the example shown in FIG. 12, the “Insert” menu item 80 of the main menu bar 82 is activated to reveal a drop-down menu. The user selects “Insert Video Player” from the drop-down menu. A video dialog box 86 is opened. The user browses 87 his computer, attached media, or remote computers to locate a video file. When the user has located the desired video file, the user selects “OK”. The video dialog box 86 disappears from view. A video player 88 appears on the digital canvas 12 surface, complete with viewing screen 90 and control panel 92. The video player 88 can be re-sized and/or placed anywhere on the digital canvas 12 surface. The video can be played by selecting the “play” button on the player control panel 92. The video and its audio component plays in the video player screen 90 directly on the digital canvas 12 surface.

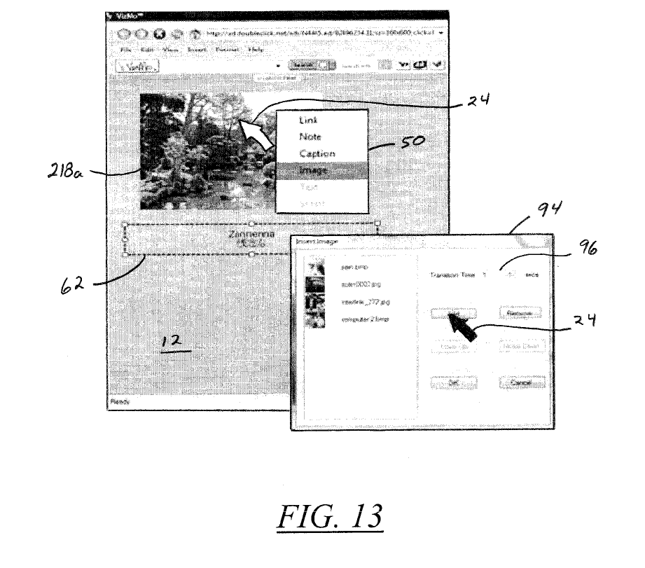

A slide show module allows a user to create a slide show from image objects located on the digital canvas surface 12, to create a slide show from image objects located at a source location, or by adding additional attributes to an object located on the digital canvas 12 surface—thus creating a slide show. In the example shown in FIG. 13, the mouse cursor 24 is placed over the photo digital object 218a and the right mouse button is depressed to activate the attributes menu 50. The user selects “Add/Edit Image” from the menu. A slide show attribute dialog box 94 is opened. The user selects “Add” and is prompted to browse to locate additional images. The user selects as many image files as he desires and sets the timing of the slide show image display interval 96. When the user is satisfied with the selections he/she selects “OK” and the slide show attribute dialog box 94 disappears from view. All of the images selected by the user will begin appearing separately within the image digital object 218a based on the sequence and timing interval selected by the user. The slide show can be controlled by an embedded control bar (forward, pause, reverse), or started or stopped via right mouse button, menu selection.

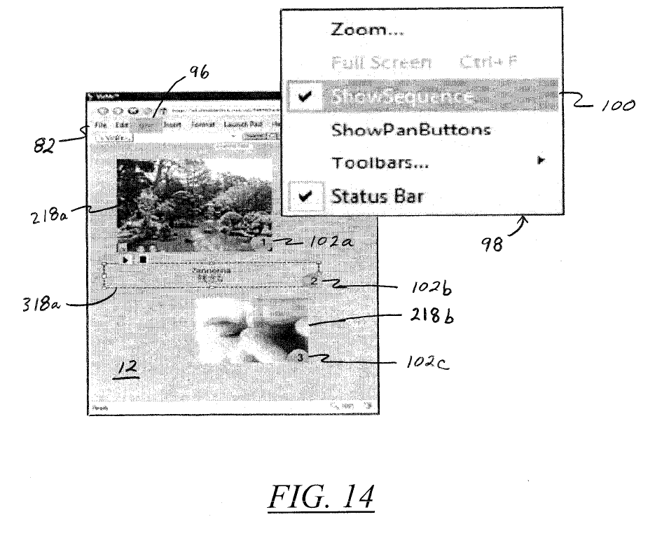

Another aspect of the system 10, a sequencing module, allows a user to set and show the sequence of objects on the digital canvas 12 surface by pointing and clicking the mouse 24. In the example shown in FIG. 14, the main menu item “View” 96 is selected to display a drop-down menu 98. The user selects “Show Sequence” 100 from the drop-down menu, wherein a dialog box is opened (not shown). The user either manually sets the sequence of the digital objects 218a, 218b, 318a, on the digital canvas 12 surface or chooses to show the sequence as recorded by the system 10 during digital canvas construction. When the user is satisfied with the selections he/she selects “OK” and the dialog box disappears from view. Numerical markers 102a, 102b, 102c, representing the sequence of the objects appear on each object. The user can choose to show an animated sequencing that will show an object-by-object construction of the canvas based on the selected sequencing of the objects.

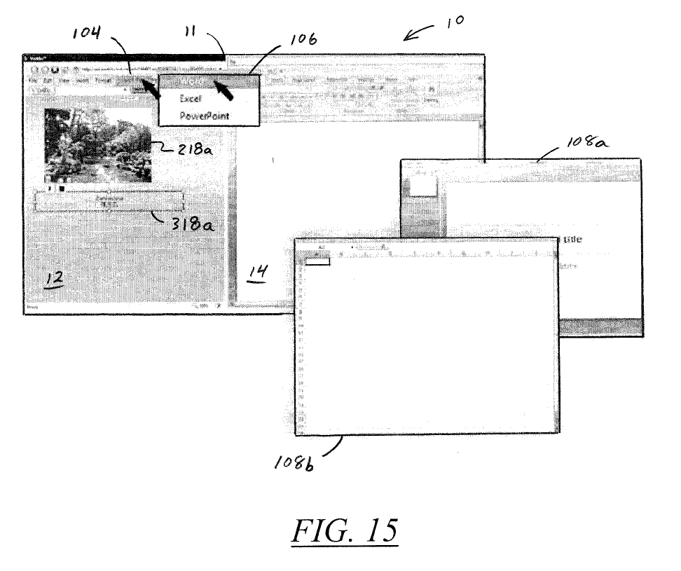

An application launch module is another aspect of the present system 10 that allows a user to launch desktop applications in the application dock 14 or in a separate frame/window as appropriate. In the example shown in FIG. 15, the main menu item “Launch Pad” 104 is selected to display a drop-down menu 106. The user selects from a list of desktop applications shown in the drop-down menu. The selected application 108a, 108b is launched and displayed in the application dock 14 on the right hand side of the virtual desktop 11. From the application, 108a, 108b the user can open any applicable saved file and/or use the application to create a new file. The application can also be launched automatically upon a double-click on any object on the canvas that has a file link attribute set to an application file.

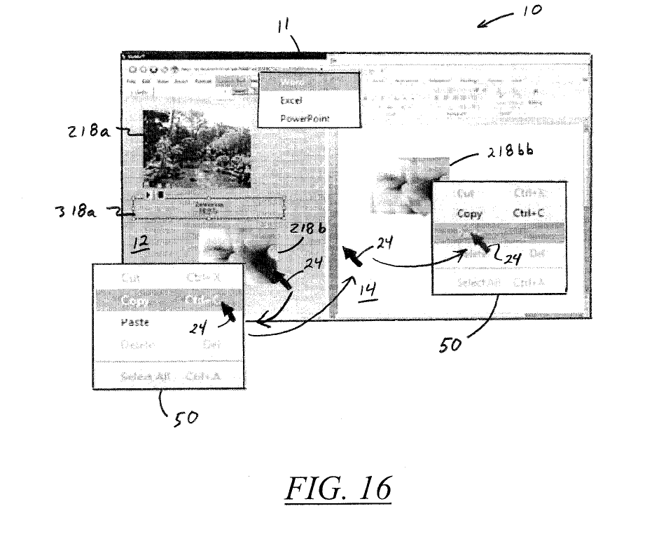

Another aspect of the present system 10 allows a user to copy and paste digital objects 218a, 218b from the digital canvas 12 to an application running in the application dock 14 or separate frame/window and vice versa. In the example of FIG. 16, the user selects a digital object 218b on the digital canvas 12 by clicking on the object with the mouse cursor 24. The user selects “Copy”, either from the main menu 50 or by pressing the “CTRL” and “C” keys on the computer's keyboard, to copy the digital object 218b. The user then places the mouse cursor 24 within the application dock 14 and selects “Paste” from menu 50 to paste a copy of the digital object 218b, shown as 218bb, in the application dock 14 (in this example a Microsoft Word document). Likewise, the user is able to copy and paste a digital object (including text) from the application to the digital canvas 12 surface.

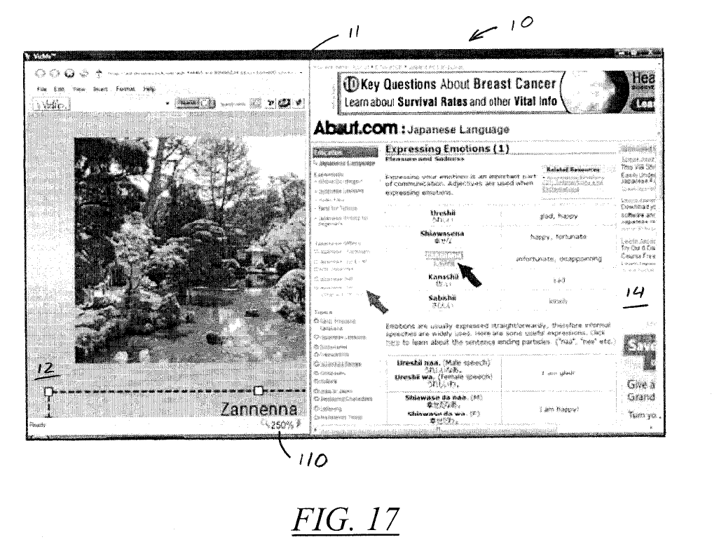

A magnification module, illustrated in FIG. 17, allows a user to adjust the scale or magnification of the digital canvas 12, allowing the user to “zoom in” and “zoom out” to view the digital canvas 12. Magnification of the digital canvas 12 can be increased to show a zoomed-in view of the photo object 218a. The user can select the “zoom-in/zoom-out” toggle switch 110 to adjust the magnification or select “Zoom” from the main menu (not shown). In the example of FIG. 17, the view is magnified to 250% of normal. All objects on the digital canvas scale to match the magnification setting.

The graphical “toggle switch” 110 allows the user to change the magnification of the entire canvas or a specified region of the canvas—creating the ability to “zoom-in or zoom-out” as desired. When this routine is activated, all of the objects on the canvas (or within the specified region) scale in size in relation to the magnification setting and maintain their relative positions relative to the other objects. A function is provided to provide a “universe view” of the entire canvas allowing quick manipulation of the canvas within its viewing window. Other functions are provided to allow for more detailed movement of the canvas within the viewing window (pan: left, right, up, down).

Referring again to FIGS. 2 and 3, the present system also includes a storage and retrieval module 120 for saving a digital canvas 12 to a digital storage medium and retrieval of saved data through a conventional serialization/deserialization process. A digital canvas can be saved to a computer hard disk, saved to an attached storage medium, distributed via e-mail attachment, or uploaded to any server connected over a network. The digital canvas can be saved and/or exported in a variety of file formats, including, but not limited to, the XHTML and Flash file formats, among others.

The system of the present disclosure includes software that is intended to run on a variety of computing platforms and devices as well as mobile devices. One or more software modules operative to, when loaded on a computing device, provide the functionality described above may also be loaded onto a computer readable media, such as a CD-ROM, floppy disc, DVD, other storage media, or other computer program product. The software modules may also be made available as a file download or operate as a plug-in to a browser, or be delivered as a web-based or ASP application. The software module may also be written or delivered via a Flash product from Adobe, Inc or Silverlight from Microsoft Corp. The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as Cold Fusion, C, SQL, C++, Java, Javascript, COBOL, assembler, CSS, Ajax, Fusebox, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There are a number of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation.

We claim:

1. A system for generating a dynamic multi-dimensional data representation within a virtual display domain, the system comprising:
a mass storage device;
a source module;
a destination module;
a user interface module connected to the mass storage device, the source module, and the destination module, the user interface module configured to display contents of the source module and the destination module, wherein the user interface module allows for selection of a digital object having predefined properties from the source module and transfer of the digital object and all of its predefined properties to the destination module without modification of computer program code.

2. The system of claim 1 wherein the user interface module further comprises a selector module and a transfer module for selecting and transferring digital objects from the source module to the destination module.

3. The system of claim 2 wherein the selector comprises at least one of the group consisting of: a drag-and-drop selection mechanism, a copy-and-paste selection mechanism, and a point-and-click selection mechanism.

4. The system of claim 1 wherein the user interface module further comprises a data acquisition and manipulation module for processing digital objects individually.

5. The system of claim 4 wherein the data acquisition and manipulation module specifies each digital object as a parent object, each parent object capable of defining a virtual display sub-domain for the placement of a plurality of child objects, each child object comprising one or more data types, each parent object having a visibility attribute configured as one of persistent visibility and transient visibility, and each child object having a visibility attribute configured as one of persistent visibility and transient visibility.

6. The system of claim 5 wherein each child object is characterized by an attribute selected from the group consisting of
a base parent object of persistent visibility located within the virtual display domain and without a child object relationship to any parent object,
a nested child object representing a fractional portion of a parent object data type and inheriting the visibility attribute of the parent object, and
a cascaded child object created within the virtual display sub-domain of a parent object and inheriting the visibility attribute of the virtual display sub-domain of the parent object.

7. The system of claim 5 wherein the user interface module further includes a scaling module to effectively change magnification of the visualized digital objects within the virtual display domain.

8. The system of claim 5 further comprising a storage and retrieval module for the dynamic multi-dimensional data representation of a plurality of digital objects in a format suitable for a data storage medium.

9. The system of claim 5 further comprising an interactive application launch module to activate a resource from a data storage medium within a software application module associated with a specified data type.

10. The system of claim 9 further comprising a file link module allowing a user to assign an attribute to a digital object, the attribute comprising a file link configured to execute a software routine via the application launch module upon command by a user.

11. The system of claim 5 further including an annotation module configured to allow a user to assign an attribute consisting of at least one of the group consisting of text data and graphical data to a digital object within the virtual display domain.

12. The system of claim 5 further including an active content module configured to allow a user to assign an attribute comprising at least one of the group consisting of audio data and video data to a digital object within the virtual display domain.

13. The system of claim 5 further including a slide show module configured to sequence visibility of a plurality of child objects assigned to a parent object wherein a user may determine the order and duration of the visibility of the plurality of child objects.

14. The system of claim 5 further including an object-sequencing module configured to sequence visibility of a plurality of digital objects within the virtual display domain.

15. The system of claim 14 wherein the object-sequencing module is configured to automatically sequence visibility of a plurality of digital objects within the virtual display domain based on the order in which the plurality of digital objects were added to the virtual display domain.

16. The system of claim 14 wherein the object-sequencing module is configured to allow a user to sequence visibility of a plurality of digital objects within the virtual display domain based on a user-selected order.

17. The system of claim 14 wherein the object-sequencing module is configured to assign a numerical marker attribute to each of the plurality of digital objects, the numerical marker attribute representing the order in the sequence for a particular digital object.

18. A computer readable medium having program code stored thereon for manipulating digital data, when executed on a computer, causing the computer to:
provide a user interface displaying a virtual display domain including a source domain and a destination domain, the source domain including one or more digital objects,
allow a user to select at least one digital object and position the digital object on the destination domain, and
allow the user to assign an attribute to the digital object.

19. The computer readable medium of claim 18 further comprising program code stored thereon causing the computer to allow a user to select at least one digital object from the source domain and position the digital object on the destination domain by at least one of the group consisting of: a drag-and-drop selection action, a copy-and-paste selection action, and a point-and-click selection action.

20. The computer readable medium of claim 18 further comprising program code stored thereon causing the computer to allow a user to manipulate one or more attributes of the digital object.

21. The computer readable medium of claim 18 further comprising program code stored thereon causing the computer to allow a user to change the magnification of at least one digital object located within the virtual display domain.

22. The computer readable medium of claim 18 further comprising program code stored thereon causing the computer to allow a user to store and retrieve a multi-dimensional representation of a plurality of digital objects within a virtual display domain.

23. The computer readable medium of claim 18 further comprising program code stored thereon causing the computer to allow a user to activate a resource from a data storage medium within the virtual display domain, the resource being associated with a specified data type.

24. The computer readable medium of claim 18 further comprising program code stored thereon causing the computer to allow a user to assign a file link attribute to a digital object, the file link configured to execute a software routine upon command by the user.

25. The computer readable medium of claim 18 further comprising program code stored thereon causing the computer to allow a user to assign an attribute consisting of at least one of text data, graphical data, audio data, and video data, to a digital object within the destination domain.

26. The computer readable medium of claim 18 further comprising program code stored thereon causing the computer to allow a user to configure a parent digital object located in the virtual display domain to include a plurality of child digital objects, wherein the user may configure the child digital objects to include transient visibility such that the plurality of digital objects displays sequentially within the parent object as a slide show.

27. The computer readable medium of claim 18 further comprising program code stored thereon causing the computer to allow a user to configure a plurality of digital objects within the virtual display domain to include transient visibility such that the plurality of digital objects displays sequentially within the virtual display domain.

28. The computer readable medium of claim 27 further comprising program code stored thereon causing the computer to allow a user to sequence the visibility of a plurality of digital objects within the virtual display domain based on a user-selected order.

29. The computer readable medium of claim 27 further comprising program code stored thereon causing the computer to sequence the visibility of a plurality of digital objects within the virtual display domain based on the order in which the digital objects were added to the virtual display domain.

30. A method for generating within a predetermined virtual display domain, a visual multi-dimensional data representation, the method comprising the steps of:
selecting at least one information unit from a source domain;
grouping at least one information unit into at least one digital object;
positioning the digital object within a plane of the virtual display domain;
locking the position of the digital object using a point-and-click menu selection module;
ordering the digital object normal to the plane of the virtual display domain;
formatting an attribute of the digital object, and
assigning a hyperlink address to the digital object, the hyperlink address having an associated data type, wherein the hyperlink address launches an application software module within a web browser, the software application module being configured for a specified data type.

31. The method of claim 30 wherein one or more of the steps are performed using an interface pointer drag-and-control mechanism.

32. The method of claim 30 wherein one or more of the steps are performed using point-and-click menu selection module.

33. The method of claim 30 wherein the digital object is positioned and locked within a vertical plane defined by a horizontal x-axis and a vertical y-axis of the virtual display domain.

34. The method of claim 33 further including the step of ordering a plurality of digital objects along a z-axis, the z-axis being normal to the vertical plane of the virtual display domain.

35. The method of claim 30 wherein the digital object attribute is selected from the group consisting of size, color, font type, border, background, and style.

36. The method of claim 30 wherein the step of grouping information units into at least one digital object further includes the assigning of at least one common property selected from the group consisting of:
an absolute position of the digital object within the virtual display domain;
a global lock state of the digital object;
format attributes of the selected digital object;
an hyperlink address for the digital object; and
metadata attributes of the digital object.

37. The method of claim 30 further including the step of modifying at least one digital object in the virtual display domain by at least one of re-sizing the digital object, rotating the digital object, and flipping the digital object.
